(19) United States
(12) Patent Application Publication
(10) Pub. No.: US 2008/0217234 A1
(43) Pub. Date: Sep. 11, 2008

(54) Device for treating fluorine-containing water

(75) Inventors: Yasuteru Sumida, Gunma (JP); Yasuyuki Kuwaki, Gunma (JP); Hiroyuki Umezawa, Gunma (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 12/073,606

(22) Filed: Mar. 7, 2008

(30) Foreign Application Priority Data
Mar. 9, 2007 (JP) 2007-059840

(51) Int. Cl. B01D 29/00

(52) U.S. Cl. 210/209; 210/266; 210/667

(57) ABSTRACT

There is disclosed a device for treating fluorine-containing water in which for-treatment water can be treated so as to set a fluorine concentration to a drainage standard or less without adding a reagent such as a pH adjuster to change a pH of the for-treatment water if possible. A treatment device includes a first treatment means for adding, to fluorine-containing for-treatment water, a reactive compound which reacts with fluorine to form a fluoride and which does not apply an OH group, so that a suspension is formed; a second treatment means for separating the suspension obtained by the first treatment means into a solid and a liquid; and a third treatment means for bringing a permeation liquid separated by the second treatment means into contact with a fluoride ion adsorbent.

### BACKGROUND OF THE INVENTION

1. Field of the Invention

The present invention relates to a device for treating fluorine-containing water. More particularly, it relates to a treatment device for agglomerating fluorine-containing water to separate the water into a solid and a liquid, and then adsorbing the separated liquid with a fluoride ion adsorbent.

2. Description of the Related Art

It is known that drainage discharged from a plant or the like and having a high fluorine concentration has an adverse affect on ecology, and a standard value of the fluorine concentration dischargeable to rivers is determined according to Clean Water Act, regulations of local governments and the like. Specifically, it is obliged to treat the drainage so as to set the fluorine concentration of the drainage to 8 mg/L or less before discharging the drainage to the rivers. Therefore, heretofore, various treatment methods for removing fluorine from such fluorine-containing water, and devices for performing the treatments have been developed.

As one of the methods and the devices, it is suggested that while adding a pH adjuster such as slaked lime to the drainage so that a pH of the drainage is 6 to 8, a calcium compound is added to form calcium fluoride, the resultant suspension is separated with a separation film to adjust the pH of a separated liquid content, and then the liquid content is brought into contact with a fluoride ion adsorbent to set the fluorine concentration in the drainage to the standard value or less.

Specifically in the above treatment method, the calcium compound is added to the fluorine-containing water (such water to be treated will hereinafter be referred to as the for-treatment water) to form the suspension containing calcium fluoride. At this time, when the calcium compound is added to the for-treatment water, the acidic suspension is formed. Therefore, slaked lime or an alkaline pH adjuster is added so as to neutralize the suspension. Subsequently, the formed suspension is separated into a solid and a liquid with the separation film, and a filtrate is adjusted into a pH of 2 to 9 if necessary.

Afterward, the pH-adjusted permeation liquid is brought into contact with the fluoride ion adsorbent to adsorb and remove fluoride ions remaining in the permeation liquid, whereby the fluorine concentration of treated water (the treated for-treatment water) is set to the standard value or less so that the water can be discharged (e.g., see Japanese Patent Application Laid-Open No. 7-47371).

The above treatment method is known as a preferable treatment method capable of removing the fluorine-containing compound and the like from the drainage to lower the fluorine concentration in the drainage. As described above, however, when the calcium compound is added, a pH adjuster such as slaked lime is added, and the pH is also adjusted before an adsorption treatment using the adsorbent. Therefore, cost of a reagent to be added and running cost of control and the like are required. There has also been a problem that the device itself for performing such treatment is complicated.

The present invention has been developed to solve such conventional technical problem, an object thereof is to provide a device for treating fluorine-containing water in which for-treatment water can be treated so as to set a fluorine concentration to a drainage standard or less without adding a reagent such as a pH adjuster to change a pH of the for-treatment water if possible.

### SUMMARY OF THE INVENTION

A device for treating fluorine-containing water according to the invention of a first aspect is characterized by comprising: a first treatment means for adding, to for-treatment water containing fluorine, a reactive compound which reacts with fluorine to form a fluoride and which does not apply an OH group, so that a suspension is formed; a second treatment means for separating the suspension obtained in the first treatment means into a solid and a liquid; and a third treatment means for bringing a permeation liquid separated by the second treatment means into contact with a fluoride ion adsorbent.

The device for treating the fluorine-containing water according to a second aspect of the invention is characterized in that in the above invention, the for-treatment water to be treated in the first treatment means is neutral or acidic, and is preferably acidic water having a pH of 6 or less.

The device for treating the fluorine-containing water according to the invention of a third aspect is characterized in that in the above invention, the compound to be added in the first treatment means is calcium chloride.

The device for treating the fluorine-containing water according to the invention of a fourth aspect is characterized in that in the invention of the first or second aspect, the fluoride ion adsorbent for use in the third treatment means is a rare earth metal or zirconium.

The device for treating the fluorine-containing water of the invention of a fifth aspect is characterized in that in the invention of the first aspect, comprising; a membrane separation tank which filters a suspension through a film constitutes the first treatment means and the second treatment means; an adsorption tower filled with a fluoride ion adsorbent constitutes the third treatment means; and a dehydration unit which dehydrates a concentrated liquid separated from the suspension.

The device for treating the fluorine-containing water of the invention of a sixth aspect is characterized in that in the invention of the fifth aspect, a permeation liquid is downward passed through the adsorption tower.

The device for treating the fluorine-containing water of the invention of a seventh aspect is characterized in that in the invention of the fifth or sixth aspect, the adsorption tower is provided with air vent means.

The device for treating the fluorine-containing water of the invention of an eighth aspect is characterized in that the invention of the fifth or sixth aspect further comprises means for detecting a pH of the permeation liquid discharged from the adsorption tower.

According to the invention of the first aspect, the device for treating the fluorine-containing water comprises the first treatment means for adding, to the for-treatment water containing fluorine, the reactive compound which reacts with fluorine to form the fluoride and which does not apply an OH group, so that a suspension is formed; the second treatment means for separating the suspension obtained in the first treatment means into the solid and the liquid; and the third treatment means for bringing the permeation liquid separated by the second treatment means into contact with the fluoride ion adsorbent. Therefore, the first treatment means forms the fluoride compound without changing the pH of the for-treatment water, the second treatment means separates the fluoride compound, and the third treatment means brings the filtrate into contact with the fluoride ion adsorbent to adsorb and remove the fluoride ions from the permeation liquid, whereby the for-treatment water can be treated so that the fluorine concentration of the water is set to the drainage standard or less.

In particular, as in the second aspect of the invention, the for-treatment water to be treated in the first treatment means is neutral or acidic, and is preferably the acidic water having a pH of 6 or less, whereby the for-treatment water dan be treated without adjusting the pH if possible so as to set the fluorine concentration of the water to the drainage standard or less. In consequence, running cost can be reduced.

Furthermore, the for-treatment water to be treated in the first treatment means is the acidic water having a pH of 6 or less, and the compound to be added in the first treatment means is calcium chloride as in the invention of the third invention. As in the invention of the fourth aspect, the fluoride ion adsorbent for use in the third treatment means is the rare earth metal or zirconium. In this case, the first treatment means forms the fluoride compound without changing the pH of the acidic for-treatment water, and then the third treatment means can allow the compound to react with the adsorbent, thereby neutralizing the for-treatment water. This obviates a need for a neutralization treatment using a pH adjuster or the like. Therefore, the running cost can remarkably be reduced.

Moreover, as in the invention of the fifth aspect, there is used the device for treating the fluorine-containing water comprising the membrane separation tank which filters the suspension through the film constitutes the first treatment means and the second treatment means; the adsorption tower filled with the fluoride ion adsorbent constitutes the third treatment means; and the dehydration unit which dehydrates the concentrated liquid separated from the suspension, whereby the treatment of the fluorine-containing water according to the invention of the first aspect can satisfactorily be performed, and the device can be simplified.

Furthermore, as in the invention of the sixth aspect, the permeation liquid is downward passed through the adsorption tower. This can eliminate a disadvantage that, for example, in a case where an adsorbent having a small specific gravity, for example, an adsorbent in which zirconium is carried by a polymer is used, the adsorbent is scattered owing to an upward flow.

Moreover, as in the invention of the seventh aspect, the adsorption tower is provided with the air vent means, which can eliminate a disadvantage that a contact portion between the permeation liquid and the adsorbent is reduced by air accumulated in the adsorption tower. In consequence, a treatment efficiency can be improved.

Furthermore, as in the invention of the eighth aspect, the device is provided with the means for detecting the pH of the permeation liquid discharged from the adsorption tower, whereby time to replace the adsorbent can be judged.

### BRIEF DESCRIPTION OF THE DRAWINGS

FIG. 1 is a schematic diagram of a device for treating the fluorine-containing water according to one embodiment in the present invention; and

FIG. 2 is a diagram showing a relation between a fluoride ion concentration of for-treatment water and a pH thereof in adsorption removal of fluoride ions by use of an adsorbent according to the embodiment.

### DESCRIPTION OF THE PREFERRED EMBODIMENT

The present invention has been developed to solve a problem that in treatment of fluorine-containing water, a pH adjuster such as slaked lime for adjusting a pH is added to increase running cost and complicated a device.

An object of the invention is to treat for-treatment water so that a fluorine concentration of the water is set to a drainage standard or less without adding a reagent such as the pH to change the pH of the for-treatment water. This object is realized by executing treatment including a first treatment means for adding, to fluorine-containing for-treatment water, a reactive compound which reacts with fluorine to form a fluoride and which does not apply an OH group, so that a suspension is formed; a second treatment means for separating the suspension obtained in the first treatment means into a solid and a liquid; and a third treatment means for bringing a permeation liquid separated by the second treatment means into contact with a fluoride ion adsorbent. An embodiment of the present invention will hereinafter be described in detail with reference to the drawing.

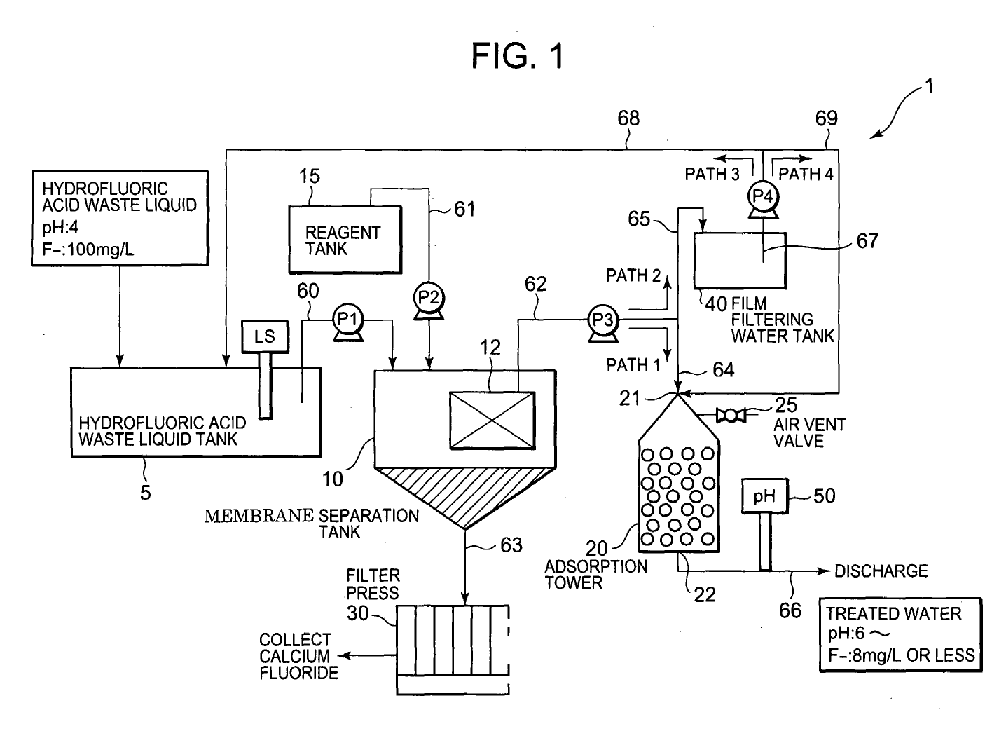

FIG. 1 is a schematic diagram of a treatment device 1 according to one embodiment of the device for treating fluorine-containing water in the present invention. The treatment device 1 of the embodiment includes a hydrofluoric acid waste liquid tank 5, a membrane separation tank 10 (which constitutes the first treatment means and the second treatment means), a reagent tank 15, an adsorption tower 20 (which constitutes the third treatment means), a dehydration unit 30 and a film filtering water tank 40.

The hydrofluoric acid waste liquid tank 5 is a tank for temporarily receiving fluorine-containing for-treatment water (fluorine-containing water), and is constituted so that the fluorine-containing for-treatment water (hereinafter referred to as the for-treatment water) from a plant or the like can flow through the hydrofluoric acid waste liquid tank 5 via a pipe. In the hydrofluoric acid waste liquid tank 5, a water level indicator LS for detecting a water level of the for-treatment water received in the tank is provided. Specifically, the water level indicator LS can detect an upper limit value and a lower limit value of the water level in the hydrofluoric acid waste liquid tank 5, and is connected to a controller described later. Then, the controller performs control so that when the water level detected by the water level indicator LS reaches a predetermined upper limit value, pumps P1, P2 and P3 described later are detected and that when a predetermined lower limit value is detected, operations of the pumps P1, P2 and P3 are stopped.

Moreover, the hydrofluoric acid waste liquid tank 5 is connected to a pipe 60. This pipe 60 is a path for allowing the for-treatment water received in this hydrofluoric acid waste liquid tank 5 to flow into the membrane separation tank 10, and the pump P1 is interposed at a middle portion of the pipe 60. The pipe 60 extends from the hydrofluoric acid waste liquid tank 5 via one end of the pipe which opens in the for-treatment water received in the hydrofluoric acid waste liquid tank 5, and is connected to the membrane separation tank 10 via the pump P1, and the other end of the pipe opens in an upper part of the membrane separation tank 10. That is, the treatment device 1 of the present embodiment is constituted so that the pump P1 can be started to pump up the for-treatment water in the hydrofluoric acid waste liquid tank 5 and supply the water to the membrane separation tank 10. An operation of the pump P1 is controlled by the above controller. Specifically, the controller controls start and stop of the pump P1, and controls the pump P1 during the operation so that a flow rate of the for-treatment water to be pumped up from the hydrofluoric acid waste liquid tank 5 and fed to the membrane separation tank 10 indicates a predetermined value (a constant flow rate).

In the membrane separation tank 10, a reagent is added to the for-treatment water from the hydrofluoric acid waste liquid tank 5 to form a suspension, and this suspension is filtered through a filter film 12 (which constitutes the second treatment means). This membrane separation tank 10 is connected to a pipe 61 in addition to the pipe 60. This pipe 61 is a path for allowing the reagent received in the reagent tank 15 to flow into the membrane separation tank 10. The pipe 61 extends from the reagent tank 15 via one end of the pipe which opens in the reagent received in the reagent tank 15, and is connected to the membrane separation tank 10 via the pump P2, and the other end of the pipe opens in the upper part of the membrane separation tank 10. In consequence, the pump P2 operates so as to supply the reagent in the reagent tank 15 to the membrane separation tank 10 via the pipe 61. An operation of the pump P2 is controlled by the controller in the same manner as in the pump P1. That is, the controller controls start and stop of the pump P2, and controls the pump P2 during the operation so that a flow rate of the reagent which flows into the membrane separation tank 10 indicates a predetermined value (a constant flow rate).

The filter film 12 separates the formed suspension into a solid and a liquid, and is disposed so as to be immersed in the suspension of the membrane separation tank 10. The filter film 12 of the embodiment includes a film body having front and rear surfaces constituted of a plurality of flat films and a frame body which surrounds peripheries of this film body. An upper portion of the frame body is provided with a water collection outlet which communicates with the film body and which is connected to the suction pump P3.

The flat films forming the film body have fine pores having predetermined diameters or smaller diameters, and can pass an only water content without passing a solid content or the like included in the suspension. In the present embodiment, the frame body is constituted of a plurality of flat films having a pore diameter of 0.25 μm and a film area of 0.4 m² (63 flat films constituting front and rear surfaces in total are used in the present embodiment).

In consequence, the solid content of the suspension is separated with the film body of the filter film 12, and the only permeation liquid (the water content) sucked into the film body by the pump P3 reaches the water collection outlet formed in an upper portion of the filter film 12.

It is to be noted that the filter film usable in the present invention is not limited to the filter film 12 described above, and any film may be applied as long as the film has a filter function. The present invention is not limited to the filter film, and another solid-liquid separation means may be used as long as the formed suspension can be separated into the solid and the liquid.

Moreover, the pump P3 is connected to a pipe 62 for guiding, from the membrane separation tank 10, the permeation liquid sucked into the film body and collected at the water collection outlet formed in the upper portion of the filter film 12.

Furthermore, the membrane separation tank 10 is constituted so that a concentrated liquid in the membrane separation tank 10 separated from the water content by the filter film 12 and including a solid content precipitated in a lower part of the membrane separation tank 10 can be conveyed to the dehydration unit 30.

In the present embodiment, a bottom part of the membrane separation tank 10 is provided with a conveyance port 14 for conveying the concentrated liquid of the membrane separation tank 10 to the dehydration unit 30. This conveyance port 14 is connected to a pipe 63 connected to the dehydration unit 30. This conveyance port 14 is openably closed by opening/closing means (not shown) (e.g., a lid member, a valve unit or the like), and periodically opened. Only in this case, the pipe 63 communicates with the inside of the membrane separation tank 10, and the concentrated liquid of the membrane separation tank 10 is conveyed to the dehydration unit 30. That is, the conveyance port 14 is usually closed by the opening/closing means, and the conveyance port 14 is periodically opened by the opening/closing means so that the concentrated liquid of the membrane separation tank 10 is conveyed to the dehydration unit 30 at this time.

The dehydration unit 30 dehydrates the concentrated liquid separated from the suspension, and a filter press is used as the dehydration unit 30 in the present embodiment. This filter press 30 is a unit for feeding, with a pump, the concentrated liquid under pressure into the device in which a filter plate and a filter cloth are superimposed, to forcibly filter the liquid.

On the other hand, one end of the pipe 62 is connected to the water collection outlet of the filter film 12 of the membrane separation tank 10, and the other end of the pipe is branched into two pipes via the pump P3. One branched pipe 64 is a path (Path 1 shown in FIG. 1) for allowing the permeation liquid from the membrane separation tank 10 through the adsorption tower 20. One end of the pipe 64 is connected to an inlet 21 formed at an upper end of the adsorption tower 20 so that the permeation liquid from the membrane separation tank 10 can flow into the adsorption tower 20.

The adsorption tower 20 adsorbs and removes fluoride ions included in the permeation liquid passed through the filter film 12, and the adsorption tower 20 is filled with a fluoride ion adsorbent. It is considered that examples of this fluoride ion adsorbent include an alumina-based adsorbent, a clay-based adsorbent, a hydrotalcite-based adsorbent, an iron-based adsorbent, a zirconium-based adsorbent, a rare earth-based adsorbent such as cerium, a magnesium-based adsorbent, a manganese-based adsorbent, an anion exchange resin and a chelate resin. It is preferable to use the rare earth-based adsorbent including a rare earth metal or the zirconium-based adsorbent including zirconium. In the present embodiment, the zirconium-based adsorbent is used.

This zirconium-based adsorbent is an adsorbent in which zirconium is carried on a polymer, and this adsorbent has a small specific gravity. Therefore, in a case where a circulation direction of the permeation liquid through the adsorption tower 20 is an upward direction from the downside, that is, a direction of upward flow (ascending flow), a problem that the adsorbent is dispersed occurs. To solve the problem, in a case where such adsorbent having the small specific gravity is used, the circulation direction of the permeation liquid through the adsorption tower 20 is preferably a downward direction from the upside, that is, a direction of downward flow (descending flow) in order to prevent the adsorbent from being scattered. To solve the problem, in the present embodiment, the permeation liquid is allowed to flow into the adsorption tower 20 from the inlet 21 formed at the upper end of the adsorption tower 20, and allowed to flow from the adsorption tower 20 via an outlet 22 formed at a lower end of the tower, and the circulation direction of the permeation liquid is the direction of the downward flow. In consequence, dispersion of the zirconium-based adsorbent having a small specific gravity can be prevented.

Moreover, the adsorption tower 20 is filled with this fluoride ion adsorbent having such an amount that the treated water satisfying drainage standard can be obtained for a predetermined long period, for example, such an amount (3000 L in the present embodiment) that the fluorine concentration of the treated water passed through the adsorption tower 20 is 8 mg/L for half a year.

Furthermore, an upper part of the adsorption tower 20 is provided with an air vent valve 25. This air vent valve 25 is air vent means for discharging formed bubbles from the permeation liquid of the adsorption tower 20. That is, a slight amount of air is present in the permeation liquid, this slight amount of air gathers to form the bubbles, and the bubbles are accumulated in the upper part of the adsorption tower 20 to disturb contact between the permeation liquid and the adsorbent. Therefore, it is preferable to discharge the bubbles. The upper part of the adsorption tower 20 is provided with the air vent valve 25 so that the bubbles can be discharged from the adsorption tower 20 via the valve. The adsorption tower 20 is provided with the air vent valve 25 in this manner, which can eliminate a disadvantage that a contact portion between the permeation liquid and the adsorbent is reduced owing to the air accumulated in the adsorption tower. Therefore, a treatment efficiency can be improved.

On the other hand, another pipe 65 branched from the pipe 62 is a path (Path 2 shown in FIG. 1) for passing the permeation liquid from the membrane separation tank 10 through the film filtering water tank 40, and one end of the pipe 65 opens in an upper part of the film filtering water tank 40 so that the permeation liquid from the membrane separation tank 10 can flow into the film filtering water tank 40. This film filtering water tank 40 is a tank for receiving the permeation liquid from the membrane separation tank 10 at a time when the adsorbent with which the adsorption tower 20 has been filled is replaced.

This film filtering water tank 40 is connected to a pipe 67 in addition to the pipe 65. The pipe 67 rises upward from one end thereof which opens in the permeation liquid of the film filtering water tank 40, extends from the film filtering water tank 40 to pass through a pump P4, and is then branched into two pipes. One branched pipe 68 is a path (Path 3 shown in FIG. 1) for returning, to the hydrofluoric acid waste liquid tank 5, the permeation liquid pumped up from the film filtering water tank 40 with the pump P4. That is, the pipe 68 branched from the pipe 67 is connected to the hydrofluoric acid waste liquid tank 5, and one end of the pipe opens in the upper part of the hydrofluoric acid waste liquid tank 5 so that the permeation liquid from the film filtering water tank 40 can flow into the hydrofluoric acid waste liquid tank 5.

Moreover, another pipe 69 is a path (Path 4 shown in FIG. 1) for passing, through the adsorption tower 20, the permeation liquid pumped up from the film filtering water tank 40 with the pump P4. Specifically, in the same manner as in the pipe 64 described above, one end of the pipe 68 is connected to the inlet 21 formed at the upper end of the adsorption tower 20 so that the permeation liquid from the film filtering water tank 40 can flow into the adsorption tower 20.

In the present embodiment, a branch point of the pipe 62 is provided with a valve unit such as a three-way valve, and this valve unit performs control so that the permeation liquid from the membrane separation tank 10 is passed through the path (Path 1) reaching the adsorption tower 20 via the pipe 64 or the path (Path 2) reaching the film filtering water tank 40 via the pipe 65. Similarly, a branch point of the pipe 67 is provided with a valve unit such as a three-way valve, and this valve unit performs control so that the permeation liquid from the film filtering water tank 40 is passed through the path (Path 3) returning to the hydrofluoric acid waste liquid tank 5 via the pipe 68 or the path (Path 4) reaching the adsorption tower 20 via the pipe 69.

In addition, when the fluoride ions of the permeation liquid are removed with the fluoride ion adsorbent in the adsorption tower 20, ion exchange is performed between an OH group of the adsorbent and the fluoride ions to discharge OH⁻ in the adsorption tower 20, so that the pH of the treated water passed through the adsorption tower 20 shifts toward an alkaline side. On the other hand, at the time to replace the fluoride ion adsorbent, the ion exchange between the OH group of the adsorbent and the fluoride ions is not easily performed, and the pH of the treated water gradually shifts toward an acidic side.

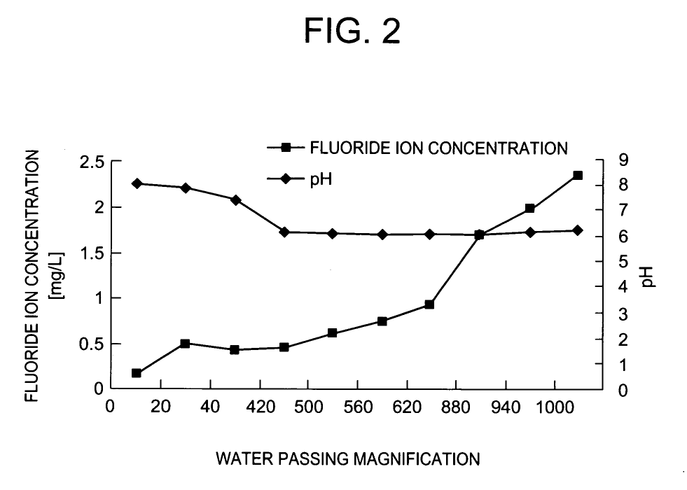

An adsorption treatment of the permeation liquid having a fluoride ion concentration of 10 mg/L and a pH of 4 was performed using the zirconium-based adsorbent, and a relation between the fluoride ion concentration and the pH of the treated permeation liquid (the treated water) was checked on conditions that a column having a diameter of 10 mm was filled with 15 ml of zirconium-based adsorbent, and the permeation liquid was passed through the column at a flow rate of 5 ml/min. Transition of a relation between a fluorine concentration and the pH of the treated water in this case is shown in FIG. 2.

As shown in FIG. 2, the permeation liquid having a pH of 4 could be treated by the reaction with the adsorbent so as to obtain a fluoride ion concentration below a drainage standard value. It was further confirmed that the treated permeation liquid (hereinafter referred to as the treated water) had a pH of 6 to 8. It could be confirmed that when the permeation liquid was continuously passed through the adsorbent (when a water passing magnification shown in FIG. 2 increases), a treatment capability of the filled fluoride ion adsorbent lowered, hence discharge of OH⁻ was reduced, and the pH of the treated water gradually shifted toward the acidic side. It has been found from the above-mentioned result that a pH change of the treated water obtained after exposing the fluoride ion adsorbent to the permeation liquid can be monitored to confirm the time to replace the fluoride ion adsorbent.

Therefore, a pH meter 50 as means for detecting the pH of the treated water passed through the adsorption tower 20 is installed on a pipe 66 connected to the outlet 22 of the adsorption tower 20. The outlet 22 of the adsorption tower 20 is provided with the pH meter 50, whereby the pH of the treated water passed through the adsorption tower 20 can be monitored, and the time to replace the adsorbent can be confirmed.

Furthermore, it can be confirmed from the result of FIG. 2 that the pH of the treated water shifts toward the alkaline side owing to the adsorption reaction with the fluoride ion adsorbent. In particular, it has been found that in a case where the pH of the permeation liquid to which the fluoride ion adsorbent has been exposed as described above is acidic (a pH of 4 in the above embodiment), the pH of the treated water to which the adsorbent has been exposed shifts toward the alkaline side, whereby the pH is neutral in a range of 6 to 8. The pH of the treated water satisfies the drainage standard (a pH of 5.8 to 8.6), and the fluorine ion concentration also satisfies the drainage standard.

In consequence, the for-treatment water can be treated so that the fluorine concentration thereof is below the drainage standard value without performing the pH adjustment using the pH adjuster if possible.

A treatment operation of the for-treatment water in the treatment device 1 of the present embodiment having the above constitution will be described. The operation of the treatment device 1 according to the present embodiment is controlled by the above-mentioned controller. The controller is control means for controlling the operation of the treatment device 1 including the pumps P1, P2, P3 and P4 and the valve units (not shown), and is constituted of a general-purpose microcomputer. Then, the controller executes the following treatment operation according to preset program. It is to be noted that an amount of the for-treatment water to be treated by the treatment device 1 of the present embodiment is 10 t/day. In the present embodiment, as the for-treatment water, a hydrofluoric acid liquid having a fluoride ion concentration of 100 mg/L and a pH of 4 is treated. In the reagent tank 15, a calcium chloride solution is received as the reagent.

First, a treatment operation of usual for-treatment water will be described. In this case, the controller controls a channel with the valve units so that the permeation liquid from the membrane separation tank 10 flows through the adsorption tower 20. First, the for-treatment water is once received in the hydrofluoric acid waste liquid tank 5. Then, in a case where the water level indicator LS detects that the water level of the for-treatment water received in the hydrofluoric acid waste liquid tank 5 reaches the predetermined upper limit value, the controller starts the pumps P1, P2 and P3. At this time, the controller controls the pumps P1, P2 and P3 so that the flow rate of the for-treatment water is a constant flow rate.

In consequence, the for-treatment water is supplied into the membrane separation tank 10 with the pump P1 at the constant flow rate, and the calcium chloride solution is supplied from the reagent tank 15 with the pump P2 at the constant flow rate. Then, the suspension in the membrane separation tank 10 is sucked into the film body of the filter film 12 with the pump P3, and the permeation liquid passed through the filter film 12 is discharged from the membrane separation tank 10 via the water collection output formed at the upper portion of the filter film 12.

That is, the for-treatment water from the hydrofluoric acid waste liquid tank 5 and the calcium chloride solution are supplied into the membrane separation tank 10 at the constant flow rate, whereby the for-treatment water and the calcium chloride solution flow into the membrane separation tank 10 at a constant ratio. Then, in the membrane separation tank 10, the following reaction occurs:

2F⁻+CaCl₂→CaF₂+2Cl⁻,

to form a suspension including calcium fluoride (CaF₂) (a first treatment step). In this reaction, fluoride ions react with calcium ions to form chloride ions only, so that the pH does not change.

Here, when a ratio of calcium chloride from the reagent tank 15 with respect to the for-treatment water flowing into the membrane separation tank 10 is increased, calcium chloride is only added in the membrane separation tank 10. Even in this case, the fluorine concentration of the for-treatment water can be reduced to a waste liquid standard or less. However, a large amount of calcium chloride is required, so that the running cost increases, which is uneconomical.

To solve the problem, in the present embodiment, amounts of the for-treatment water and the calcium chloride solution to be supplied to the membrane separation tank 10 with the pumps P1, P2 are controlled so that the fluoride ion concentration of the permeation liquid passed through the filter film 12 and discharged from the membrane separation tank 10 is about 30 mg/L. Specifically, in a case where a 30% calcium chloride solution is received in the reagent tank 15 and this 30% calcium chloride solution is added at a ratio of 9 L/day, the flow rates of the for-treatment water and the calcium chloride solution allowed to flow into the membrane separation tank 10 with the pumps P1, P2 are quantitatively controlled by the controller. Moreover, an amount of the permeation liquid pumped up from the membrane separation tank 10 with the pump P3 is quantitatively controlled by the controller in accordance with the operations of the pumps P1, P2 so that the water level in the membrane separation tank 10 can be maintained at a constant water level owing to inflow of the for-treatment water and the calcium chloride solution through the membrane separation tank 10.

It is to be noted that in the present embodiment, the calcium chloride solution is added to the for-treatment water, but a substance to be added to the for-treatment water is not limited to calcium chloride of the present embodiment. Any substance may be added as long as the substance is a reactive compound which reacts with fluorine in the for-treatment water to form a fluoride and which does not apply an OH group. The compound to be added to the for-treatment water is not limited to the solution of the present embodiment, and may be a solid such as a particle-like or powder-like solid.

On the other hand, the suspension including the formed calcium fluoride is separated into a solid and a liquid with the filter film 12 immersed in the membrane separation tank 10 (a second treatment step). That is, the pump P3 is operated to suck the only water content of the suspension into the film body of the filter film 12, and the solid content (including calcium fluoride) included in the suspension is attached to the surface of the filter film 12. In consequence, calcium chloride is added to form a part of the fluoride ions of the for-treatment water into solid calcium chloride, and this solid is separated into a solid and a liquid with the filter film 12, whereby a part of the fluoride ions of the for-treatment water can be removed, and the fluoride ion concentration of the permeation liquid can be set to about 30 mg/L.

It is to be noted that the solid content including calcium fluoride attached to the filter film 12 floats in the membrane separation tank 10, and settles in a lower part of the membrane separation tank 10. Afterward, the liquid (a concentrated liquid) including this solid content is periodically conveyed to the filter press (the dehydration unit) 30, and dehydrated. The dehydrated solid content is collected as a half solid containing highly concentrated calcium fluoride, and allowed to react with strong acid (sulfuric acid or the like), whereby the content can be reused as hydrofluoric acid.

On the other hand, the water content (the permeation liquid) sucked into the film body of the filter film 12 then reaches the water collection outlet, and is fed to the adsorption tower 20 with the pump P3 via the pipes 62, 64 (Path 1 of FIG. 1). It is to be noted that the permeation liquid which flows into the adsorption tower 20 has a fluoride ion concentration of about 30 mg/L as described above, and has not satisfied the drainage standard yet.

The permeation liquid flows into the adsorption tower 20 from the inlet 21 formed at the upper end of the tower, and flows downward while coming in contact with the fluoride ion adsorbent in the adsorption tower 20. In this process, the fluoride ions of the permeation liquid are adsorbed and removed by the zirconium-based adsorbent provided in the adsorption tower 20 owing to the following reaction (a third treatment step):

Zr—OH+F⁻→Zr—F+OH⁻.

In consequence, the fluorine concentration of the treated water can be set to the drainage standard or less.

Furthermore, in the above adsorption reaction, the ion exchange between the OH group of the zirconium-based adsorbent and the fluoride ions is performed to discharge OH⁻, and the pH of the treated water shifts toward the alkaline side. Then, the waste liquid including neutral or acidic fluorine is treated as the for-treatment water, and the compound (a reactive compound) allowed to react with the for-treatment water in the membrane separation tank 10 is a compound (calcium chloride in the present embodiment) which does not apply any OH group, whereby the pH is not changed and maintained to be neutral or acidic until the water reaches the adsorption tower 20. Therefore, the treated water subjected to the adsorption treatment in the adsorption tower 20 may be adjusted only to set the pH of the water to the drainage standard (a pH of 5.8 to 8.6), and the treated water which satisfies the drainage standard can be obtained without performing any pH adjustment if possible.

In particular, as in the present embodiment, the waste liquid including acidic fluorine having a pH of 6 or less is treated as the for-treatment water and the compound allowed to react with the for-treatment water in the membrane separation tank 10 is the compound (calcium chloride in the present embodiment) which does not apply any OH group, whereby the pH is not changed and maintained to be acidic until the water reaches the adsorption tower 20. In consequence, the pH of the treated water can be set to the drainage standard without performing any neutralization treatment by use of the pH adjuster.

On the other hand, when the water level indicator LS of the hydrofluoric acid waste liquid tank 5 detects a predetermined lower limit value, the controller stops the pumps P1, P2 and P3. In consequence, the treatment operation of the for-treatment water in the treatment device 1 is stopped. Then, in a case where the water level indicator LS detects that the predetermined upper limit value is obtained attain, the controller starts the pumps P1, P2 and P3 to resume the treatment operation of the for-treatment water by the treatment device 1.

Next, an operation of the treatment device 1 at a time when the adsorbent provided in the adsorption tower 20 is replaced will be described. In the present embodiment, the fluorine waste liquid having a pH of 4 is used as the for-treatment water, so that it is detected with the pH meter 50 that the pH of the treated water treated in the adsorption tower 20 is neutral as described above. On the other hand, when the adsorbent in the adsorption tower 20 comes close to the replacement time, the pH of the treated water detected with the pH meter 50 gradually shifts toward the acidic side. When the pH of the treated water detected with the pH meter 50 comes close to the lower limit value of the drainage standard, it is recognized that ability of the adsorbent lowers, and it is the time to replace the adsorbent. In the device of the present embodiment, when the pH of the treated water detected with the pH meter 50 is as low as a pH of 6, the adsorbent is replaced.

At this adsorbent replacement time, for example, when the pH meter 50 detects that the pH of the treated water is 6, the controller blocks the path (i.e., Path 1) for passing the permeation liquid from the membrane separation tank 10 through the adsorption tower 20, and controls so as to pass the liquid through the film filtering water tank 40. In consequence, the permeation liquid from the membrane separation tank 10 is fed to the film filtering water tank 40 with the pump P3 via the pipes 62, 65 (Path 2 of FIG. 1), and received in the film filtering water tank 40. It is to be noted that at the adsorbent replacement time, the operation of the pump P4 remains to be stopped.

Subsequently, when the replacement of the adsorbent is completed and the operation switch is turned off, the controller starts the pump P4. At this time, the controller controls the channel based on an output of the water level indicator LS of the hydrofluoric acid waste liquid tank 5 so that the permeation liquid pumped up from the film filtering water tank 40 is passed through the hydrofluoric acid waste liquid tank 5 in a case where the water level indicator LS detects a value between the upper limit value and the lower limit value. In consequence, the permeation liquid from the film filtering water tank 40 is returned to the hydrofluoric acid waste liquid tank 5 via the pipes 67, 68 (Path 3 of FIG. 1), and supplied again to the membrane separation tank 10 with the pump P1 to perform the above-mentioned treatment operation.

On the other hand, when the water level indicator LS of the hydrofluoric acid waste liquid tank 5 detects the lower limit value, the pump P3 stops, so that the liquid can flow into the adsorption tower 20. Therefore, the controller controls the channel so as to pass, through the adsorption tower 20, the permeation liquid pumped up from the film filtering water tank 40. In consequence, the permeation liquid from the film filtering water tank 40 is fed to the adsorption tower 20 via the pipes 67, 69 (Path 4 of FIG. 1). Then, the liquid is passed through the adsorption tower 20 and treated below the drainage standard as described above. Afterward, the liquid is discharged from the adsorption tower 20 via the outlet 22. It is to be noted that the controller operates the pump P4 for a predetermined time, and then stops the operation.

As described above in detail, according to the present invention, the for-treatment water can be treated so as to set the pH and the fluorine concentration of the water to the drainage standard or less without performing the neutralization treatment by use of the pH adjuster or the like if possible or without performing any neutralization treatment as in the present embodiment. In consequence, the running cost can be reduced, and the treatment device 1 can be simplified.

What is claimed is:

1. A device for treating fluorine-containing water, comprising:
a first treatment means for adding, to for-treatment water containing fluorine, a reactive compound which reacts with fluorine to form a fluoride and which does not apply an OH group, so that a suspension is formed;
a second treatment means for separating the suspension obtained in the first treatment means into a solid and a liquid; and
a third treatment means for bringing a permeation liquid separated by the second treatment means into contact with a fluoride ion adsorbent.

2. The device for treating the fluorine-containing water according to claim 1, wherein the for-treatment water to be treated in the first treatment means is neutral or acidic, and is preferably acidic water having a pH of 6 or less.

3. The device for treating the fluorine-containing water according to claim 1 or 2, wherein the compound to be added in the first treatment means is calcium chloride.

4. The device for treating the fluorine-containing water according to claim 1 or 2, wherein the fluoride ion adsorbent for use in the third treatment means is a rare earth metal or zirconium.

5. The device for treating the fluorine-containing water according to claim 1, comprising:
a membrane separation tank which filters a suspension through a film constitutes the first treatment means and the second treatment means;
an adsorption tower filled with a fluoride ion adsorbent constitutes the third treatment means; and
a dehydration unit which dehydrates a concentrated liquid separated from the suspension.

6. The device for treating the fluorine-containing water according to claim 5, wherein the permeation liquid is downward passed through the adsorption tower.

7. The device for treating the fluorine-containing water according to claim 5 or 6, wherein the adsorption tower is provided with air vent means.

8. The device for treating the fluorine-containing water according to claim 5 or 6, further comprising:
means for detecting a pH of the permeation liquid discharged from the adsorption tower.
